(19) United States
(12) Patent Application Publication
(10) Pub. No.: US 2011/0034602 A1
(43) Pub. Date: Feb. 10, 2011

(54) Thixotropic reactive composition

(75) Inventor: David Tobler, Winterthur (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/923,862

(22) Filed: Oct. 12, 2010

Related U.S. Application Data
(62) Division of application No. 10/584,845, filed on Mar. 7, 2007.

(30) Foreign Application Priority Data
Jan. 23, 2004 (EP) 04001406.0

(51) Int. Cl. C08L 33/10; C08K 5/092

(52) U.S. Cl. 524/297; 525/123; 525/107; 525/100; 525/102; 524/560

(57) ABSTRACT

The present invention relates to reactive compositions which at least one compound A having at least two reactive groups which are selected from the group comprising isocyanate, epoxide, alkoxysilane, and mixtures thereof and also at least one polymeric thixotropic agent B prepared by homopolymerizing a (meth)acrylate B1 or by copolymerizing a (meth)acrylate B1 with at least one further (meth)acrylate, the (meth)acrylate mixture possessing an average (meth)acrylate functionality ƒ̅ of 2.5 to 4.5. The (meth)acrylate B1 here contains three or more (meth)acrylate groups. The invention additionally discloses the use of the compound B as a thixotropic agent.

This is a Division of application Ser. No. 10/584,845 filed Mar. 7, 2007, which in turn is a National Phase of PCT/EP2005/050262, filed Jan. 21, 2005, which claims priority of European Application No. 04001406.0, filed Jan. 23, 2004. The disclosure of the prior applications is hereby incorporated by reference herein in their entirety.

### BACKGROUND

1. Technical Field

The present invention pertains to the field of the thixotroping of reactive compositions, especially of adhesives and sealants.

2. Prior Art

For the application of an adhesive or sealant the thixotropy is an important feature. Adhesives and sealants are typically stored in cartridges, pails or drums. For application they are withdrawn from this storage vessel by pumps, or by expressing using a cartridge gun or follower plates, and are applied to the substrate to be bonded or sealed, typically by means of a nozzle, where appropriate by a static mixer. To maximize conveying efficiency and minimize force expenditure it is advantageous for the adhesive or sealant to have a very low viscosity. On the other hand, the applied adhesive or sealant ought to remain in the applied shape and not run off after application. This is enormously important particularly in the case of thick layers or in the case of vertical or overhead applications. For maximizing shape retention a very high viscosity is of advantage.

These requirements of conveying and shape preservation are completely contradictory. The skilled worker is aware, however, of the phenomenon of thixotropy. With this effect a material becomes less viscous as soon as it is agitated, and solidifies again when the agitation ceases again. This effect is therefore utilized by the majority of commercial adhesives and sealants. The adhesive, or the moderately viscous binder, is typically admixed with an additive. Examples of such thixotropic agents are inorganic substances such as, for example, bentonites or pyrogenic silicas, or organic substances such as castor oil derivatives, specific polyamides or polyureas.

Thus, for example, DE 23 60 019 describes a polyurea thixotropic agent which results from the reaction of primary and/or secondary polyamines, monofunctional alcohols and/or amines with diisocyanate compounds.

A thixotropic agent for polyurethane compositions based on a urea derivative in a nondiffusing carrier material is described in EP 1 152 019 A1, for example.

(Meth)acrylates having a functionality of more than two are used primarily for fast-crosslinking and extremely resistant coating materials. U.S. Pat. No. 3,663,467 describes a porous polymer based on trimethylolpropane trimethacrylate which is used for absorbing phenol from hexane. EP 0 732 348 A1 describes a moisture-curing polymer composition containing fine particles of a copolymer of a mono(meth)acrylate with a monomer having two or more (meth)acryloyloxy groups, the fraction of the latter being not more than 10 mol % of the copolymer and being said to lead to increased extension and impact strength.

### SUMMARY

The object was to find a new form of thixotroping reactive compositions. Surprisingly it was found that this can be achieved by a thixotropic composition as claimed. In particular it was found that the compound B is suitable as a thixotropic agent for broad-spectrum use in reactive compositions.

### DETAILED DESCRIPTION OF EMBODIMENTS

The present invention relates to a thixotropic composition which comprises at least one compound A having at least two reactive groups which are selected from the group comprising isocyanate, epoxide, alkoxysilane, and mixtures thereof, and also at least one polymeric thixotropic agent B prepared by homopolymerizing a (meth)acrylate B1 or by copolymerizing a (meth)acrylate B1 with at least one further (meth)acrylate. The (meth)acrylate mixture here possesses an average (meth)acrylate functionality ƒ̅ of 2.5 to 4.5.

By “(meth)acrylate” is meant throughout the present documents an ester of acrylic acid or methacrylic acid, the term therefore encompassing both methacrylates and acrylates.

By “alkoxysilane” is meant throughout the present document an organosilicon compound in which at least one organic radical is bound via a C—Si bond to the silicon atom and which possesses at least one further organic radical which is bound via an O—Si bond to the silicon atom radical.

By “epoxy” is meant throughout the present document the one oxirane group, formula (I), of which the glycidyl group, formula (II), represents the preferred variant.

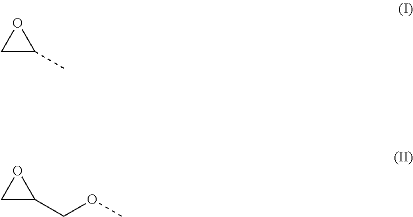

By “poly” in “polyol”, “polyamine”, “polymercaptane” and “polyisocyanate” is meant in the present document molecules which formally contain two or more of the respective functional groups.

The term “polyurethane” encompasses in the present document all polymers which are prepared by the diisocyanate polyaddition process. This includes even those polymers which are virtually or entirely free from urethane groups, such as polyether-polyurethanes, polyester-polyurethanes, polyether-polyureas, polyureas, polyester-polyureas, polyisocyanurates, polycarbodiimides, etc.

By “(meth)acrylate functionality” is meant the number of (meth)acrylate groups per molecule, and, accordingly, reference is made to “monofunctional”, “difunctional”, “trifunctional”, “tetrafunctional”, and “pentafunctional” (meth)acrylates.

The “average (meth)acrylate functionality ƒ̅” is calculated according to the following formula:

$$\overline{f} = \frac{{\sum }_{i}^{ } {n}_{i} {f}_{i}}{{\sum }_{i}^{ } {n}_{i}}$$

In this formula nᵢ is the number of moles of the respective (meth)acrylate in the (meth)acrylate mixture and ƒᵢ is its (meth)acrylate functionality. In order to prevent any absences of clarity it is mentioned additionally that ƒ̅ is determined taking into account only substances which have at least one (meth)acrylate function; in other words, any other substances that may be present in this mixture during the copolymerization, such as solvents, plasticizers, compound A or the reactants of A, for example, are not taken into account.

The composition of the invention comprises at least one compound A. This compound A possesses at least two reactive groups. These reactive groups are isocyanate, epoxide or alkoxysilane groups. The compound A may also contain mixtures of these groups. Thus, for example, the compound A may contain simultaneously alkoxysilane and isocyanate groups or simultaneously alkoxysilane and epoxy groups or epoxy and isocyanate groups. It is even possible for the compound A to contain simultaneously alkoxysilane, epoxy and isocyanate groups. It is preferred, however, for the compound to contain at least two identical groups.

The compound A is in particular a polymer or oligomer.

In one embodiment the compound A is a compound A3 which is a polyurethane prepolymer containing at least two isocyanate groups. This polyurethane prepolymer is preparable from at least one polyol and at least one polyisocyanate.

This reaction may take place by the polyol and the polyisocyanate being reacted by typical methods, such as at temperatures of 50° C. to 100° C. for example, with or without the use of suitable catalysts, the amount of polyisocyanate added being such that its isocyanate groups are present in a stoichiometric excess in relation to the hydroxyl groups of the polyol. The excess of polyisocyanate is chosen such that the residual free isocyanate group content of the resulting polyurethane prepolymer A3, after the reaction of all hydroxyl groups of the polyoly, is 0.1% to 15% by weight, preferably 0.5% to 5% by weight, based on the total polyurethane prepolymer A3. Where appropriate, the polyurethane prepolymer A3 can be prepared using plasticizers, the plasticizers used containing no isocyanate-reactive groups.

As polyols for preparing the polyurethane prepolymer A3 it is possible for example to use the following commercially customary polyols or any desired mixtures of them:

Polyoxyalkylene polyols, also called polyether polyols, which are polymerization products of ethylene oxide, 1,2-propylene oxide, 1,2- or 2,3-butylene oxide, tetrahydrofuran or mixtures thereof, optionally polymerized by means of a starter molecular having two or more active hydrogen atoms, such as, for example, water, ammonia or compounds having two or more OH or NH groups, such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the aforementioned compounds. It is possible to use polyoxyalkylene polyols which have a low degree of unsaturation (measured according to ASTM D-2849-69 and expressed in milliequivalents of unsaturation per gram of polyol (meq/g)), prepared for example by means of what are called double metal cyanide complex catalysts (DMC catalysts), but also polyoxyalkylenepolyols having a higher degree of unsaturation, prepared for example by means of anionic catalysts such as NaOH, KOH or alkali metal alkoxides.

Particular suitability is possessed by polyoxyalkylene diols or polyoxyalkylene triols, especially polyoxypropylene diols or polyoxypropylene triols.

Especially suitable are polyoxyalkylene diols or polyoxyalkylene triols having a degree of unsaturation of less than 0.02 meq/g and having a molecular weight in the range from 1000 to 30 000 g/mol, and also polyoxypropylene diols and triols having a molecular weight of 400 to 8000 g/mol. “Molecular weight” or “molar weight” in the present document always refers to the molecular weight average Mₙ.

Likewise particularly suitable are what are called “EO-endcapped” (ethylene oxide-endcapped) polyoxypropylene diols or triols. The latter are special polyoxypropylene-polyoxyethylene polyols which are obtained, for example, by alkoxylating straight polyoxypropylene polyols, after the end of the polypropoxylation, with ethylene oxide, and which as a result contain primary hydroxyl groups.

Hydroxy-functional polybutadienes.

Polyester polyols, prepared for example from dihydric to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols, with organic dicarboxylic acids or their anhydrides or esters, such as, for example, succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or mixtures of the aforementioned acids, and also polyester polyols of lactones such as ε-caprolactone, for example.

Polycarbonate polyols of the kind obtainable by reacting, for example, the abovementioned alcohols—those used to synthesize the polyester polyols—with dialkyl carbonates, diaryl carbonates or phosgene, polyacrylate and polymethacrylate polyols.

These stated polyols have an average molecular weight of 250 to 30 000 g/mol and an average OH functionality in the range from 1.6 to 3.

Further to these stated polyols it is possible to use low molecular mass dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols, and other polyhydric alcohols, low molecular mass alkoxylation products of the aforementioned dihydric and polyhydric alcohols, and mixtures of the aforementioned alcohols when preparing the polyurethane prepolymer A3.

The polyurethane prepolymer A3 is prepared using commercially customary polyisocyanates. Examples that may be mentioned include the following polyisocyanates, which are very well known in polyurethane chemistry:

tolylene 2,4- and 2,6-diisocyanate (TDI) and any desired mixtures of these isomers, diphenylmethane 4,4′-diisocyanate (MDI), the positionally isomeric diphenylmethane diisocyanates, phenylene 1,3- and 1,4-diisocyanate, 2,3,5,6-tetramethyl-1,4-diisocyanatobenzene, 1,6-hexamethylene diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, cyclohexane 1,3- and -1,4-diisocyanate and any desired mixtures of these isomers, 1-isocyanato-3,3,5-trimethyl-5-isocyanatomethylcyclohexane (i.e., isophorone diisocyanate or IPDI), perhydrodiphenyl methane 2,4′- and 4,4′-diisocyanate (HMDI), 1,4-diisocyanato-2,2,6-trimethylcyclohexane (TMCDI), xylene m- and p-diisocyanate (XDI), tetramethylxylylene 1,3- and 1,4-diisocyanate (TMCDI), 1,3- and 1,4-bis(isocyanatomethyl)cyclohexane, and oligomers and polymers of the aforementioned isocyanates, and also any desired mixtures of the aforementioned isocyanates. Particular preference is given to diisocyanates, especially MDI, TDI, HDI, and IPDI.

In a further embodiment the compound A is a compound A1 which is a diglydicyl ether of bisphenol A, bisphenol F, bisphenol A/F, a mixture or an oligomer thereof. The designation ‘A/F’ refers in this context to a mixture of acetone with formaldehyde, that is used as a reactant in its preparation. Among the diglycidyl ethers the compound is preferably a liquid resin. Owing to the preparation processes for these resins it is clear that constituents of higher molecular mass are also present in the liquid resins. Liquid resins of this kind are available for example as Araldite® GY 250, Araldite® PY 304, Araldite® GY 282 (formerly Vantico, now Huntsman) or D.E.R.® 331 (Dow).

In addition it is possible for there to be further glycidyl ethers in the composition, known to the skilled worker as resins or reactive diluents. Particularly suitable reactive diluents are glycidyl ethers of alkyl radicals, alkylene radicals, and phenols, such as, for example, hexanediol diglycidyl ether, polypropylene glycol diglycidyl ether, trimethylolpropane triglycidyl ether, phenyl glycidyl ether or cresol glycidyl ether.

In a further embodiment the compound A is a compound A2 which represents a polymer having at least two alkoxysilane groups. On the one hand the compound A2 represents a compound A2-1 and on the other hand it represents a compound A2-2.

The compound A2-1 is a polyurethane prepolymer which contains at least two alkoxysilane groups. A2-2 can be prepared from a prepolymer containing isocyanate groups, corresponding to the identity and preparation of A3, and at least one compound which at least one alkoxy group and organic radical thereof, an NCO-reactive group, in particular a mercapto-alkoxysilane or an amino-alkoxysilane. In particular they are selected from the group comprising 3-aminopropyltrimethoxysilane, 3-aminopropyldimethoxymethylsilane, aminomethyltrimethoxysilane, aminomethyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4 amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, N-(2-aminoethyl)-3-aminopropyltrimethoxysilane, N-(2-aminoethyl)-3-aminopropyldimethoxymethylsilane, 7-amino-4-oxaheptyldimethoxymethylsilane, 3-mercaptopropyltrimethoxysilane, 3 mercaptopropylmethyldimethoxysilane, 3-mercaptopropyldimethylmethoxysilane, and also their analogs with ethoxy or isopropoxy groups instead of the methoxy groups. In one embodiment the aminoalkoxysilane is an adduct of one of the aminoalkoxysilanes just specified with a maleic ester or fumaric ester, as described for example in U.S. Pat. No. 5,364,955.

The compound A2-2 is a polyether containing at least two alkoxysilane groups and are very well known to the skilled worker under the term of MS polymers and are described for example in U.S. Pat. No. 6,207,766 in column 4 lines 27 to 54 and in U.S. Pat. No. 3,971,751.

The compounds A2-2 can be prepared by a hydrosilylation reaction from polyether containing at least two C═C double bonds, in particular from allyl-terminated polyoxyalkylene polymers, and from a compound HSi(R¹)ₐ(OR²)₃₋ₐ. R¹ and R² here are independently of one another a C₁-C₈-alkyl radical, in particular methyl or ethyl, and a represents the value 0 or 1, in particular the value 0. For the hydrosilylation reaction a catalyst is used, typically a platinum catalyst. One of the advantages of the compounds A2-2 is that they can be prepared without the use of isocyanates and another is that these compounds have particularly low viscosity, and so are very suitable for use in one-component moisture-curing compositions.

For the compound A2 it is preferred if the alkoxysilane groups are trimethoxy or triethoxy groups, especially trimethoxy groups.

The compound A can also be obtained by reaction of a polyurethane prepolymer A3 containing at least two isocyanate groups with at least one compound AX.

The compound AX contains an NCO-reactive group, especially primary or secondary amino group or SH group or OH group, and also one or more epoxide or alkoxysilane groups. The polyurethane prepolymers A3 suitable for this purpose, and also their preparation, have already been described earlier in this specification. As compound AX it is possible for example to use aminosilanes, mercaptosilanes or hydroxy-epoxides. In one particularly preferred embodiment the compound AX is a Michael adduct of aminoalkylsilanes and maleic or fumaric diesters, as described for example in EP 0 403 921.

Particularly suitable aminosilanes are the aminosilanes selected from the group comprising 3-aminopropyltrimethoxysilane, 3 aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4 amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, N-(2-aminoethyl)-3-aminopropyltrimethoxysilane, N-(2-aminoethyl)-3-aminopropyldimethoxymethylsilane, 7-amino-4-oxaheptyldimethoxymethylsilane, and also their analogs with ethoxy or isopropoxy groups instead of the methoxy groups. Preference is given to 3-aminopropyltrimethoxysilane and 3-aminopropyltriethoxysilane.

Particularly suitable mercaptosilanes are the mercaptosilanes selected from the group comprising 3-mercaptopropyltrimethoxysilane, 3-mercaptopropylmethyldimethoxysilane, 3-mercaptopropyldimethylmethoxysilane, and their analogs with ethoxy or isopropoxy groups instead of the methoxy groups. Preference is given to 3-mercaptopropyltrimethoxysilane and 3-mercaptopropyltriethoxysilane.

Hydroxy-epoxides can be prepared from an incomplete reaction of polyols with epichlorohydrin. They are also always present as by-products in the typically obtainable glycidyl ethers of polyols, and can be isolated by typical separating operations. Examples of such hydroxy-epoxides are trimethylolpropane diglycidyl ether (present as a mixture in trimethylolpropane triglycidyl ether), glycerol diglycidyl ether (present as a mixture in glycerol triglycidyl ether), and pentaerythritol triglycidyl ether (present as a mixture in pentaerythritol tetraglycidyl ether). Preference is given to using trimethylolpropane diglycidyl ether, which occurs in a relatively high proportion in typically prepared trimethylolpropane triglycidyl ether. It is, however, also possible to use other, similar hydroxy-epoxides, especially glycidol, 3 glycidyloxybenzyl alcohol or hydroxymethylcyclohexene oxide. Of further preference is the β-hydroxy ether of the formula (In) present at about 15% in commercially customary liquid epoxy resins prepared from bisphenol A (R═CH₃) and epichlorohydrin, and also the corresponding b hydroxy ethers which are formed when bisphenol F (R═H) or the mixture of bisphenol A and bisphenol F is reacted with epichlorohydrin.

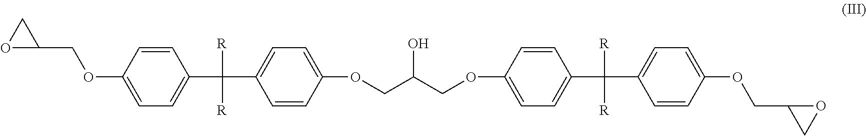

The compound A can also be obtained by a reaction of a polymer A3-1 containing at least two isocyanate-reactive groups with at least one compound AY. The compound AY here contains an NCO group and also one or more alkoxysilane group. The polymer A3-1 here may for example be a polyol, a polymercaptane or a polyamine. Also suitable for this purpose of course are polymers which at the same time contain two or more different NCO-reactive groups. Particularly suitable polyols in this context include the polyols already described for the preparation of the polyurethane prepolymers A3. Particularly suitable polymercaptanes include mercapto-terminated polyalkylenes and Thiocols.

A further possibility for compounds A3-1 are products from the reaction of polyols, polymercaptanes, polyols with polyisocyanates, specifically with a deficit amount of isocyanate. The deficit amount of isocyanates used is tailored in this case to the functionality of the polyisocyanate, polyol, polyamine or polymercaptane and also its molecular weight, so as to produce compounds A3-1 with not too high a viscosity. A further possibility is to prepare A3-1 as adducts or chain extensions of a polyurethane prepolymer A3 with diamines, diols or dimercaptanes in a stoichiometric excess.

The compound AY is an isocyanatosilane, in particular an isocyanatosilane selected from the group (3-isocyanatopropyl)trimethoxysilane (isocyanatomethyl)methyldimethoxysilane, (isocyanatomethyl)trimethoxysilane, and their analogs with ethoxy or isopropoxy groups instead of the methoxy groups.

The composition of the invention further comprises at least one polymeric thixotropic agent B. This thixotropic agent may be obtained on the one hand by a homopolymerization reaction of a (meth)acrylate B1 which contains three or more (meth)acrylate groups. The thixotropic agent may be obtained on the other hand by a copolymerization reaction of a (meth)acrylate B1 with at least one further (meth)acrylate, specifically such that the (meth)acrylate mixture possesses an average (meth)acrylate functionality ƒ̅ of 2.5 to 4.5.

The fraction of the polymeric thixotropic agent B is preferably between 0.1 and 10% by weight, in particular between 0.5% and 5% by weight, based on the weight of the composition.

A thixotropic agent B here must not contain any substantial fractions of functional groups which react with an NCO, epoxide or alkoxysilane group, since otherwise the composition lacks storage stability. Of course it is preferred that this fraction is zero or substantially zero. (Meth)acrylates B1 having three or more (meth)acrylate groups can be obtained from an esterification of triols and higher polyols. All (meth)acrylates used may be compounds of low or high molecular mass. Preference is given to using (meth)acrylates having a (meth)acrylate equivalent weight of 85 to 400 g/eq, in particular 85-150 g/eq, preferably 95-125 g/eq, corresponding to the molecular weight divided by the number of (meth)acrylate groups per molecule. The (meth)acrylate B1 preferably contains only (meth)acrylate groups as functional groups, and is preferably selected from the group comprising glycerol tri(meth)acrylate, tris(2-hydroxyethyl)isocyanurate tri(meth)acrylate, trimethylolpropane tri(meth)acrylate, ditrimethylolpropane tetra(meth)acrylate, pentaerythritol tetra(meth)acrylate, glucose penta(meth)acrylate, sorbitol hexa(meth)acrylate, dipentaerythritol hexa(meth)acrylate, and their ethoxylated or propoxylated analogs.

Particularly suitable are (meth)acrylates having three, four or five (meth)acrylate groups per molecule. Trifunctional (meth)acrylates are particularly preferred.

If the (meth)acrylate B1 is copolymerized with a further monomer (meth)acrylate, the (meth)acrylate mixture preferably has an average (meth)acrylate functionality ƒ̅ of 2.5 to 3.5, with particular preference between 2.8 and 3.2.

Particularly preferred are monofunctional or difunctional (meth)acrylates, which can be copolymerized with tetrafunctional, pentafunctional or hexafunctional (meth)acrylates.

Particularly suitable monofunctional (meth)acrylates are the monomers selected from the group comprising methyl (meth)acrylate, isobornyl (meth)acrylate, tetrahydrofurfuryl (meth)acrylate, 2-ethylhexyl (meth)acrylate and isobutyl (meth)acrylate.

Particularly suitable difunctional (meth)acrylates are the (meth)acrylates selected from the group comprising C₂-Cₛ-alkylene di(meth)acrylate, especially hexane di(meth)acrylate, ethylene glycol (meth)acrylat, diethylene glycol (meth)acrylate, triethylene glycol (meth)acrylate, tetraethylene glycol (meth)acrylate, and also epoxy di(meth)acrylates.

By epoxy di(meth)acrylates are meant not only the reaction products of bisphenol A diglycidyl ethers with (meth)acrylic acid, but also esters of bisphenol A or alkoxylated bisphenol A with (meth)acrylic acid, especially with a molecular weight between 450 and 1000 g/mol.

Preference is given above all to those (meth)acrylates which have no inherent odor or only a slight inherent odor. This is particularly important for interior applications, where such an inherent odor is disruptive.

The polymerization of the (meth)acrylates is accomplished by means of free radicals. These free radicals may be generated in a way which is known to the skilled worker, in particular by means of light or heat, from a free-radical donor. The free radicals are preferably generated from organic peroxides. Organic peroxides used advantageously are those having a decomposition temperature T_{1/2} (1 h) of between 100° C. and 50° C., in particular between 70 and 95° C. The stated decomposition temperature is known to the skilled worker under the specialist English term “1 h half-life temperature”. Organic peroxides which have proven particularly preferred are those which are a peroxide of a fatty acid, especially dilauroyl peroxide.

On the basis of the free-radical donor used in the polymerization, the composition of the invention typically contains at least traces of the organic free-radical donor used for the free-radical polymerization of the (meth)acrylates, or its derivative reaction products.

The composition may be one-component or two-component. In the case of the two-component composition the curing of the first component, which comprises the at least one compound A and at least one polymeric thixotropic agent B, is cured by a second component, known as the hardener component. The second component comprises a compound H which reacts with the compound A or triggers a self-crosslinking. Typical examples of these compounds H are, for example, primary polyamines, polymercaptanes, polyols or water.

In the case of the one-component composition it cures by virtue of the fact that the compound A cures through the influence of heat or atmospheric moisture. If heat curing takes place, the composition may include a blocked or heat-reacting hardener H′ which undergoes substantially no reaction with the compound A at room temperature but at an elevated temperature, typically at a temperature of more than 80° C., undergoes deblocking and releases a compound H or reacts itself. Examples of a blocked or heat-reacting hardener H′ are dicyandiamide or carboxylic anhydrides for a compound A having epoxy groups, or an acid-blocked amine for a compound A having epoxy groups or isocyanate groups.

Preferably the composition is one-component. If the compound A contains alkoxysilane and/or isocyanate groups, the composition is preferably one-component and moisture-curing, curing in particular with moisture originating from the air.

In addition to the at least one compound A and the at least one polymeric thixotropic agent B, the composition of the invention may further comprise at least one constituent known to the skilled worker for polyurethanes, silanes or epoxides, such as fillers, plasticizers, solvents, adhesion promoters, thixotropic agents, stabilizers, especially UV or heat stabilizers, or catalysts.

In the case of the two-component compositions the aforementioned constituents may in each case be present in both components or only in one component.

As a filler, carbon black is particularly preferred. The fraction of the filler, relative to the total composition, is typically between 25% and 50% by weight, in particular between 25% and 45% by weight, preferably between 30% and 40% by weight, based on the weight of the composition, especially for an adhesive or sealant.

In one embodiment of the present invention the composition contains no carbon black. It is therefore possible to produce light-colored compositions and also colored compositions, especially white compositions, more particularly white polyurethane adhesives.

Particularly suitable adhesion promoters are trialkoxysilanes, especially trimethoxysilanes. These are preferably methacryloyloxy-, epoxy-, mercpato- or vinyl-silanes, especially methacryloyloxypropyltrimethoxysilane, 3-glycidyloxypropyltrimethoxysilane, 3-mercaptopropyltrimethoxysilane or vinyltriethoxysilane. With further preference the adhesion promoter may comprise adducts between trialkoxysilanes which carry primary amino groups, especially 3 aminopropyltrimethoxysilane or 3-(2-aminoethylamino)propyltrimethoxysilane, and mercaptosilanes or epoxysilanes, especially 3-glycidyloxypropyltrimethoxysilane, 3-mercaptopropyltrimethoxysilane.

Particularly suitable plasticizers are phthalates or adipates, especially dialkyl phthalates, preferably diisodecyl phthalate, or dialkyl adipates, preferably dioctyl adipate.

In one embodiment of the present invention the composition has a solvent content of less than 5% by weight, in particular of less than 1% by weight, and a plasticizer content of less than 5% by weight, in particular of less than 1% by weight. With preference the composition is free of solvent, in particular free of solvent and free of plasticizer.

It is particularly preferred for the polymeric thixotropic agent B to be a constituent of a plasticizer-free composition.

The composition contains advantageously less than 1% by weight, preferably less than 0.1% by weight, in particular 0% by weight, of substances considered to be VOCs (Volatile Organic Compound).

There are two preferred ways of preparing the composition. In a first version the compound A is prepared to start with, in the absence of moisture in the case of moisture-reactive compounds A. For this purpose the polymeric thixotropic agent B, which is polymerized in a separate production process, initiated by free-radical donors, from the (meth)acrylate or the relevant (meth)acrylates, and where appropriate has been prepared in further worked-up form, is added, advantageously with vigorous stirring. Prior to the addition, this thixotropic agent is in the form in particular of a powder, preferably a spray-dried powder, or in the form of a solution or dispersion, in particular in an adipate or phthalate plasticizer.

The thixotropic agent is advantageously added at a temperature of the kind typically chosen for the preparation of the compound A, in particular at 50-80° C.

Subsequently, if present, the further constituents are typically mixed in. In particular the plasticizers, solvents, catalysts or stabilizers, where present, may have been admixed at least in part to the compound A or to its starting product even prior to the addition of thixotropic agent.

In a second version the thixotropic agent B is polymerized in situ. This version of the preparation takes place advantageously as follows. In a first step the compound A is prepared, in the absence of moisture in the case of moisture-reactive compounds A. It may be of advantage that the compound A even at this early point contains solvent or plasticizer. Subsequently the (meth)acrylate or the (meth)acrylates, either together or in succession, are added to the compound A. Subsequently, typically, a polymerization catalyst, where used, is added, and then a free-radical donor. In certain circumstances, however, it may be of advantage for any polymerization catalyst and the free-radical donor to have been already added prior to the addition of the (meth)acrylate to the compound A. In situ homopolymerization or copolymerization of the thixotropic agent B takes place with stirring at a temperature of typically 80-95° C. Subsequently, typically, the further constituents, if present, are mixed in.

If the compound A is a moisture-reactive compound, it is necessary to ensure in each step during the preparation of the composition that, on the one hand, not only the reactants but also the constituents contain as little water as possible and, on the other hand, that any preparation and processing steps take place with strict exclusion of moisture, and in particular under inert gas.

Production is followed by dispensing into packaging appropriate for storage, transport, and application. The packaging in question comprises, in particular, cartridges, pails, hobbocks, pouches or Unipack casings. In the choice of packaging materials it is necessary to ensure that the pack is impervious and offers sufficient moisture protection so that the shelf life of at least 6 months, in particular at least 9 months, is ensured without hardening or substantial thickening.

In the case of application as a two-component composition, the first and second components are intimately mixed with one another, using a mixing gun or a mixer, for example, and the mixture is immediately contacted at least partly with the surface of any desired substrate. As a result of a reaction, in particular an addition reaction, the reactive composition A reacts with the compound H and an article is produced which is in frictional contact with the cured composition.

In the case of application as a one-component composition the isocyanate groups and/or alkoxysilane groups of the compound A come into contact with moisture, whereupon they react with water and crosslink. This cures the composition. Alternatively the water needed for curing can come from the air (atmospheric humidity), or the composition can be contacted with a water-containing component, by being spread-coated, for example, with a smoothing agent, for example, by being sprayed, or by means of immersion processes, or else the composition can have a water-containing component added to it, in the form for example of a hydrous paste, which is mixed in via a static mixer, for example.

The composition described can be used as an adhesive, sealant, coating or covering. Its preferred use is as an adhesive or sealant. In the sealant utility, joints in the construction of built structures and industrial products, in particular, are filled and sealed with the composition.

In the adhesive utility, the composition is employed in particular for the bonding of diverse substrates, such as for bonding components in the production of automobiles, rail vehicles, ships or other industrial products, and also as a coating or covering for diverse articles and/or variable substrates. Preferred coatings are protective paints, seals, protective coatings, and primers. Among the coverings, floor coverings in particular may be mentioned as preferred. Such coverings are produced by, typically, pouring a composition onto the substrate and leveling it, where it cures to form a floor covering. Floor coverings of this kind are used, for example, for offices, living areas, hospitals, schools, warehouses, multistory carparks and other private or industrial applications.

Where the compound A is a compound which carries epoxide groups and is cured by means of a second, hardener component, in particular with polyamines, this composition can be employed to great advantage in the construction of built structures, such as buildings, bridges, and tunnels. For these purposes it is necessary for the adhesives employed to exhibit very good adhesion to concrete, mineral substrates, and steel and also to have great inherent strengths.

The composition is at least partly contacted with the surface of any desired substrate. Preference is given to uniform contacting in the form of a sealant or adhesive, a coating or a covering, in the regions which for use require a connection in the form of an adhesive bond or seal, or else whose substrate is to be covered. It may well be necessary for the substrate or article to be contacted to have to undergo physical and/or chemical pretreatment prior to contacting, such as by sanding, sandblasting, brushing or the like, for example, or by treatment with cleaning products, solvents, adhesion promoters, adhesion-promoter solutions or primers, or the application of a tie coat or a sealer. Contacting is followed in the case of moisture-reactive compositions, as already mentioned, by curing under the influence of water.

Finally an article is produced which is in frictional contact with the cured composition.

The compositions of the invention are thixotropic. This is manifested in qualities which include that of an improved flow resistance. Moreover, the compositions of the invention preferably have a thixotropic index (TI) of more than 6, in particular of more than 10, preferably of more than 20, which is a product of the ratio of the viscosities at a shear rate of 1 s⁻¹ and at a shear rate of 100 s⁻¹, measured at a temperature of 20° C.:

$$TI = \frac{η ( 1 {s}^{- 1} )}{η ( 100 {s}^{- 1} )} \geq 1$$

It has further emerged that these compositions are also distinguished by a greatly reduced gloss. Too high a gloss can be disadvantageous for adhesives and sealants, since those with a high gloss value can reflect light and therefore tend to be more conspicuous. Low degrees of gloss are preferred, therefore, primarily on esthetic grounds. It has been possible to demonstrate that the compositions of the invention exhibit a greatly reduced gloss as compared with their counterparts without thixotropic agent. Accordingly the polymeric thixotropic agent B can also be used as a polymeric matting agent for adhesives, sealants, and coverings.

It has additionally been found that the polymeric thixotropic agent B contains small particles which are slightly different depending on operating parameter. Particle sizes which have been found particularly suitable are those of less than 5 micrometers, particularly those of less than 0.5 micrometer. Excessively large particles lead to particle settlement and hence to storage stability problems, and also to a deterioration in the thixotroping properties.

### EXAMPLES

### Production of Composition Comprising Thixotropic Agent B

### 1.) Composition Containing Isocyanate Groups

### Preparation of a Polyurethane Prepolymer Prep1

2155 g of Acclaim® 4200 N polyol (Bayer), 4310 g of Caradol® MD34-02 polyol (Shell) and 1035 g of methylenediphenyl 4,4′-diisocyanate (MDI; Desmodur® 44 MC L, Bayer) were reacted by a known method at 80° C. to give an NCO-terminated prepolymer. The reaction product had a titrimetrically determined free isocyanate group content of 2.36% by weight. Prep1 is an example of a compound A3.

To prepare a 5% by weight composition, 470 g of Prep1 were admixed with 25 g of a (meth)acrylate B or a mixture of a (meth)acrylate B with a further (meth)acrylate, and the mixture was blanketed with nitrogen and heated at 90° C. with stirring. It was admixed with a further mixture, consisting of 1.5 g of dilauroyl peroxide and 3.5 g of diisodecyl phthalate. The combined mixture was stirred while the formation of gel was awaited, which occurred after about 10 minutes. Subsequently the mixture was stirred further at 90° C. for about 30 minutes more and then cooled to room temperature.

To prepare a 10% by weight composition, an analogous procedure was followed using 445 g of Prep1 and 50 g of a (meth)acrylate B or mixture of a (meth)acrylate B with a further (meth)acrylate.

### Suitability of the Thixotropic Agent

To assess its suitability as a thixotropic agent, the respective composition was dispensed into an aluminum cartridge and applied as a triangular bead to a horizontal surface; after 7 days the bead was cut open and the deviation from the triangular shape was assessed in accordance with the following assessment code with regard to % by weight of B, based on the weight of the composition:

1 no substantial deviation at 5% by weight

2 mild deviation at 5% by weight, no deviation at 10% by weight

3 strong deviation at 5% by weight, slight deviation at 10% by weight

4 very strong deviation at 10% by weight

The suitability of the compositions B as thixotropic agents was the thixotropic agents prepared as follows:

TABLE 1
Suitability as thixotropic agents.

| Designation | Monomer | ƒ̅ | Suitability |
|---|---|---|---|
| 1 | Dipentaerythritol pentaacrylate | 5 | 2 |
| | (DiPEPA) | | |
| 2 | Ditrimethylolpropane tetraacrylate | 4 | 2 |
| | (DiTMPTTA) | | |
| 3 | Pentaerythritol tetraacrylate | 4 | 1 |
| | (PETA-4) | | |
| 4 | Trimethylolpropane trimethacrylate | 3 | 1 |
| | (TMPTMA) | | |
| 5 | Trimethylolpropane triacrylate | 3 | 1 |
| | (TMPTA) | | |
| 6 | Pentaerythritol triacrylate (PETA-3) | 3 | 1 |
| 7 | Tris(2-hydroxyethyl)isocyanurate | 3 | 2 |
| | triacrylate | | |
| 8 | Isobutyl methacrylate/PETA-4 | 3 | 1 |
| | (3 mol/7 mol) | | |
| 9 | Methyl methacrylate/PETA-4 | 3 | 1 |
| | (3 mol/7 mol) | | |
| 10 | Isobutyl methacrylate/PETA-4 | 2.7 | 2 |
| | (3 mol/4 mol) | | |
| 11 | Methyl methacrylate/PETA-4 | 2.7 | 2 |
| | (3 mol/4 mol) | | |
| Ref. 1 | Hexanediol diacrylate | 2 | 3 |
| Ref. 2 | Methyl methacrylate/PETA-4 | 1.3 | 4 |
| | (9 mol/1 mol) | | |
| Ref. 3 | Methyl methacrylate/TMPTA | 1.2 | 4 |
| | (9 mol/1 mol) | | |
| Ref. 4 | Isobornyl methacrylate (IBOMA) | 1 | 4 |
| Ref. 5 | Isobornyl acrylate (IBOA) | 1 | 4 |
| Ref. 6 | Methyl methacrylate (MMA) | 1 | 4 |
| Ref. 7 | 2-Ethylhexyl acrylate (EHA) | 1 | 4 |
| Ref. 8 | Isobutyl methacrylate | 1 | 4 |
| Ref. 8 | 1,6-Hexanediol dimethacrylate | 2 | 3 |
| | (HDDMA) | | |
| Ref. 9 | 1,6-Hexanediol diacrylate (HDDA) | 2 | 3 |

### Epoxy Resin-Based Composition

100 g of trimethylolpropane trimethacrylate (TMPTMA) were dissolved with stirring at 90° C. in 1000 g of liquid bisphenol A diglycidyl ether resin (BADGE) (Araldite® GY 250). The reaction vessel was evacuated three times and flooded with nitrogen. The reaction was carried out under nitrogen. After about 30 minutes, 3 g of dilauroyl peroxide were added and the mixture was stirred vigorously. This produced a glassy mass of high viscosity. The epoxy content of this paste, referred to below as EP-Pastel, was 4.6 eq/kg. This EP-Pastel had a B content of 9.1% by weight.

### Production of Adhesives

### 1. Polyurethane Adhesives

One-component moisture-curing polyurethane adhesives of the composition indicated in Table 2 were produced. For a 5 kg batch in accordance with the quantities of Table 2, first of all the (meth)acrylate was added to Prep1 and plasticizer, and the mixture was blanketed with nitrogen and heated at 90° C. with stirring. At 90° C. the peroxide was added. The mixture was subsequently stirred for 10 minutes more and then cooled to 50° C. At this point the drying agent and also carbon black and kaolin were mixed in, and mixing was carried out under reduced pressure for 15 minutes. This gave a homogeneous black paste. Finally the catalyst was added, a further 10 minutes of stirring were carried out, and the mixture was dispensed into aluminum cartridges.

TABLE 2
Polyurethane adhesive compositions (Amounts in % by weight)

| Designation | KP-Ref. 1 | KP1 | KP2 | KP3 | KP4 | KP5 | KP6 |
|---|---|---|---|---|---|---|---|
| Prepolymer | 45.0 | 45.0 | 45.0 | 45.0 | 45.0 | 45.0 | 45.0 |
| (Prep1) | | | | | | | |
| Diisodecyl | 24.7 | 24.7 | 24.7 | 24.7 | 24.7 | 24.7 | 24.7 |
| phthalate | | | | | | | |
| TMPTMA | 0.00 | 1.75 | 2.25 | 3.00 | 3.50 | 4.00 | 5.25 |
| Dilauroyl | 0.30 | 0.30 | 0.30 | 0.30 | 0.30 | 0.30 | 0.30 |
| peroxide | | | | | | | |
| Drying agent | 0.30 | 0.30 | 0.30 | 0.30 | 0.30 | 0.30 | 0.30 |
| Carbon black | 15.0 | 15.0 | 15.0 | 15.0 | 15.0 | 15.0 | 15.0 |
| Kaolin | 14.6 | 12.9 | 12.4 | 11.6 | 11.1 | 10.6 | 9.35 |
| Catalyst | 0.10 | 0.10 | 0.10 | 0.10 | 0.10 | 0.10 | 0.10 |

### 2. Epoxy Resin Adhesives

### 2.1. 1-Component Thermosetting Epoxy Resin Adhesives

EP-Pastel was weighed out together with bisphenol A diglycidyl ether, the epoxy reactive diluent, dicyandiamide, and the fillers into a sheet metal canister and homogenized at 50° C. under reduced pressure for 1 h.

Subsequently a sheet of adhesive was produced from the adhesive and cured at 180° C. for 30 minutes. Dumbbell specimens were produced by punching and then tested for tensile strength, breaking extension, and elasticity modulus (dumbbells, length: 75 mm, width: 4 mm, thickness: 2 mm; testing speed: 2 mm/min (DIN 53 504)) (see Table 7).

TABLE 3
Compositions of 1-comp. epoxy resin adhesives
(all amounts in parts by weight)

| Designation | KE-Ref. 1 | KE1 |
|---|---|---|
| BADGE | 60.0 | 10.0 |
| EP-Paste1 | — | 55.0 |
| Polypropylene glycol diglycidyl ether | 10.0 | 10.0 |
| Dicyandiamide | 5.0 | 5.0 |
| Wollastonite | 12.0 | 12.0 |
| Chalk | 13.0 | 13.0 |
| Total: | 100.0 | 105.0 |
| Overall concentration of B [%] | 0 | 4.7 |

### 2.2 2-Component Epoxy Resin Adhesives

EP-Pastel was weighed out together with bisphenol A diglycidyl ether, the reactive diluent and the fillers into a sheet metal canister and homogenized at 40° C. under reduced pressure for 1 h.

Subsequently a mixture of amines and accelerator was added to the canister and stirred under reduced pressure for 5 minutes more. The adhesive was transferred to a cartridge and immediately discharged into a sample casting mold.

The samples were stored under standard conditions for 7 days, then removed from the mold and subjected to testing in a 3-point flexural test: dumbbells, length: 150 mm, width: 10 mm, thickness: 10 mm; testing speed: 2 mm/min (in analogy to ISO 178) (see Table 8).

TABLE 4
Compositions of 2-comp. epoxy resin adhesives
(all amounts in parts by weight)

| | | | | |
|---|---|---|---|---|
| Designation | KE-Ref. 2 | KE2 | KE-Ref. 3 | KE3 |

First component (resin)

| | | | | |
|---|---|---|---|---|
| BADGE | 60.0 | 10.0 | 68.5 | — |
| EP-Paste1 | — | 55.0 | — | 75.0 |
| Polypropylene glycol diglycidyl | 10.0 | 10.0 | — | — |
| ether | | | | |
| Wollastonite | 20.0 | 20.0 | 10.0 | 10.0 |
| Chalk | 20.0 | 20.0 | 18.0 | 18.0 |

Second comoponent (hardener)

| | | | | |
|---|---|---|---|---|
| Isophoronediamine | 13.0 | 13.0 | 13.4 | 13.4 |
| 1,3-Xylylenediamine | 15.0 | 15.0 | 15.6 | 15.6 |
| 2,4,6 Tri(dimethylaminomethyl)- | 5.0 | 5.0 | 5.2 | 5.2 |
| phenol | | | | |
| Total: | 143.0 | 148.0 | 130.70 | 137.2 |
| Overall concentration of B [%] | 0 | 3.3 | 0 | 4.9 |

### 3. Alkoxysilane Adhesives

Preparation of Prep2:

Prep2 is the reaction product of an isocyanate-terminated prepolymer (prepared by conventional preparation process from Acclaim®12200 (Bayer) and IPDI, NCO/OH ratio of 2) with the aminosilane from Example 5 of U.S. Pat. No. 5,364,955. This reaction takes place conventionally. Prep2 has a titrimetrically determined free isocyanate group content of 0.00% by weight.

Production of KS1:

In a commercially customary 1 kg mixer, 270 g (100 parts) of the alkoxysilane-functional polyurethane prepolymer Prep2 were mixed with 100 g (37 parts) of DIDP plasticizer for 5 minutes. Added to this mixture were 20 g (7 parts) of trimethylolpropane trimethacrylate (TMPTMA, Fluka Chemie) and 2.4 g (0.9 part) of dilauroyl peroxide (Fluka Chemie), and the mixture was heated at 90° C. It was then stirred at 90° C. under reduced pressure for 30 minutes until a highly viscous, flow-resistant mass had formed. Then 54 g (20 parts) of titanium dioxide and 325 g (120 parts) of coated chalk were mixed in at 60° C. for 15 minutes. Subsequently 8 g (3 parts) of diaminosilane (Silquest® A-1120), 2.7 g (1 part) of UV stabilizer (Tinuvin 5060, Ciba Specialities) and 5.4 g (2.1 parts) of vinylsilane (Silquest® A-171) were added and stirred in without heating but under reduced pressure for 10 minutes. Finally a further 1.18 g (0.5 part) of dibutyltin dilaurate (DBTL) and 10 g (4 parts) of DIDP plasticizer were added and mixed in under reduced pressure for 10 minutes.

A similar procedure was adopted for the examples indicated in Table 5. In the examples KMS1 and KMS-Ref1, instead of the alkoxysilane-functional polyurethane prepolymer Prep2 (as an example of a compound A2-1), a commercial MS polymer (MS-S303H, available from Kaneka Corp.) was employed (as an example of a compound A2-2). In the case of the reference adhesives KS-Ref1 and KMS-Ref1, however, no TMPTMA or peroxide was used, and hence the step of heating to 90° C. was also omitted.

TABLE 5
Compositions of alkoxysilane adhesives (all amounts in parts by weight.

| Designation | KS1 | KS2 | KS-Ref. 1 | KMS1 | KMS-Ref. 1 |
|---|---|---|---|---|---|
| Prep2 | 100 | 100 | 100 | — | — |
| MS-S303H (Kaneka Corp.) | — | — | — | 100 | 100 |
| Diisodecyl phthalate | 37 | 37 | 37 | 39 | 46 |
| TMPTMA | 7 | 4 | 0 | 7 | 0 |
| Dilauroyl peroxide | 0.9 | 0.9 | 0 | 0.9 | 0 |
| Titanium dioxide | 20 | 20 | 20 | 20 | 20 |
| Coated chalk | 120 | 120 | 120 | 120 | 120 |
| Aminosilane (Silquest A-1120) | 3 | 3 | 3 | 3 | 3 |
| Tinuvin 5060 | 1 | 1 | 1 | 1 | 1 |
| Vinylsilane (Silquest A-171) | 2 | 2 | 2 | 2 | 2 |
| Dibutyltin dilaurate | 0.44 | 0.44 | 0.48 | 1.82 | 1.82 |
| Diisodecyl phthalate | 4 | 4 | 19 | 6 | 6 |
| Total | 295.34 | 292.34 | 302.48 | 300.72 | 299.82 |
| Overall concentration of B [%] | 2.4 | 1.4 | 0 | 2.3 | 0 |

### Results

The following properties were determined on these adhesives, and are summarized in Tables 6 to 9:

Sagging: A triangular bead (height 22 mm, base 8 mm) was applied to a glass plate (1). Subsequently the plate was immediately set up vertically (2) and cured at room temperature and 50% relative humidity. An assessment was made of the flow resistance, by measuring the sagging of the adhesive (3). Depicted diagrammatically:

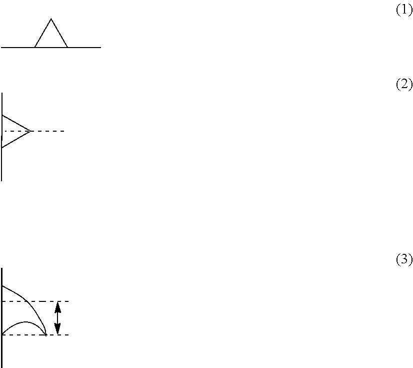

Viscosity: The viscosity was determined with a viscometer (Rheomat) (5 s⁻¹, 20° C., plate Ø=25 mm, slot thickness 1 mm)

Adhesion to glass: The glass surface (floatglass, available commercially from Rocholl, Schonbrunn, Germany) was pretreated with Sika® activator (available commercially from Sika Schweiz AG). After a flash-off time of 30 minutes the adhesive was applied and was cured for 7 days at room temperature and 50% relative humidity. Subsequently the sample was stored in water at room temperature for 7 days, then stored in a drying cabinet at 80° C. for 1 day, and finally for 7 days under hot humid conditions (70° C. and 100% relative humidity). After each storage period the adhesion was tested by means of the bead test. In this test an incision is made at the end just above the adhesive area. The incized end of the bead is held with round-ended tweezers and pulled from the substrate. This is done by carefully rolling the bead onto the tip of the tweezers, and placing a cut down to the bare substrate perpendicular to the direction in which the bead is pulled. The speed at which the bead is removed by pulling should be selected such that it is necessary to make a cut about every 3 seconds. The test distance must be at least 8 cm. An assessment is made, after the bead has been removed by pulling, of the adhesive which remains on the substrate (cohesive fracture). The attachment properties are evaluated by estimating the cohesive fraction of the attachment area:

1=>95% cohesive fracture

2=75-95% cohesive fracture

3=25-75% cohesive fracture

4=<25% cohesive fracture

5=adhesive fracture

Tensile shear strength: to DIN EN 1465 (20 mm/min)

Tensile strength: to DIN 53504 (200 mm/min)

Breaking extension: to DIN 53504 (200 mm/min)

Elasticity modulus: to DIN 53504 (200 mm/min)

Tear propagation resistance DIN 53515 (500 mm/min)

Thixotropic Index (TI):The ratio of the viscosities at a shear rate of 1 s⁻¹ and 100 s⁻¹, measured at a temperature of 20° C.

$$TI = \frac{η ( 1 {s}^{- 1} )}{η ( 100 {s}^{- 1} )} \geq 1$$

Extrusion force (EF): For the determination of the extrusion force a cartridge filled with adhesive was conditioned at 23° C. for 12 hours and then opened and fitted with a screw-on nozzle of 5 mm. And, using a Zwick 1120 extrusion apparatus, a measurement was made of the force required to extrude the adhesive with a speed of 60 mm/min. The figure reported is an average value after extrusion of 85 ml.

TABLE 6
Properties of the polyurethane adhesives.

| Designation | KP-Ref. 1 | KP1 | KP2 | KP3 | KP4 | KP5 | KP6 |
|---|---|---|---|---|---|---|---|
| Amount of B [%] | 0.00 | 1.75 | 2.25 | 3.00 | 3.50 | 4.00 | 5.25 |
| Sagging [mm] | 32 | 14 | 9 | 2 | 0.5 | 0 | 0 |
| Viscosity [Pas] | 256 | 1200 | 1750 | 2360 | 3150 | 3770 | 6180 |
| Adhesion to glass | | | | | | | |
| 7 d/RT | 1 | 1 | 1 | 1 | 1 | 1 | 1 |
| 7 d/water | 1 | 1 | 1 | 1 | 1 | 1 | 1 |
| 1 d/80° C. | 1 | 1 | 1 | 1 | 1 | 1 | 1 |
| 7 d/hot-humid | 1 | 1 | 1 | 1 | 1 | 1 | 1 |
| Tensile shear strength | 4.8 | 4.5 | 4.7 | 5.7 | 5.8 | 5.7 | 6.5 |
| [MPa] | | | | | | | |
| Tensile strength [MPa] | 7.4 | 7.9 | 8.2 | 8.6 | 8.7 | 9.4 | 9.7 |
| Breaking extension [%] | 370 | 340 | 330 | 340 | 330 | 340 | 320 |
| Elasticity modulus | 2.4 | 3.1 | 3.5 | 3.8 | 4.1 | 4.3 | 4.5 |
| (0.5-1.0%)[MPa] | | | | | | | |
| Thixotropic Index (TI): | 5.1 | 15.4 | 22.7 | 23.5 | 25.5 | 31.3 | N/A^{x} |
| Extrusion force [N] | 29 | 463 | 500 | 694 | 827 | 965 | 1515 |

^{x}Viscosity at a shear rate of 1 s⁻¹ can no longer be measured

TABLE 7
Properties of the 1-component epoxy resin adhesives.

| Designation | KE-Ref. 1 | KE1 |
|---|---|---|
| Overall concentration of B [%] | 0 | 4.7 |
| Sagging after 1 week under standard | >50 | 0 |
| conditions [mm] | | |
| Sagging after curing (30′ 180° C.) [mm] | >50 | 10 |
| Tensile strength [MPa] | 62.0 | 71.0 |
| Breaking extension [%] | 2.5 | 4.5 |
| Elasticity modulus (0.5-1.0%) [MPa] | 3200 | 3175 |

TABLE 8
Properties of the 2-component epoxy resin adhesives.

| Designation | KE-Ref. 2 | KE2 | KE-Ref. 3 | KE3 |
|---|---|---|---|---|
| Overall concentration | 0 | 3.3 | 0 | 4.9 |
| of B [%] | | | | |
| Sagging after 1 week standard | >50 | 2 | >50 | 0 |
| conditions [mm] | | | | |
| Maximum force 3-point | 25.5 | 24.1 | 11.2 | 11.1 |
| flexing [MPa] | | | | |
| Initial modulus 3-point | 4780 | 4160 | 3710 | 3770 |
| flexing [MPa] | | | | |

TABLE 9
Properties of the alkoxysilane adhesives.

| Designation | KS1 | KS2 | KS-Ref. 1 | KMS1 | KMS-Ref. 1 |
|---|---|---|---|---|---|
| Amount of B [%] | 2.4 | 1.4 | 0 | 2.3 | 0 |
| Flow resistance | good | good | poor | good | poor |
| Sagging [mm] | 3 | 5 | >50 | 3 | >50 |
| Tensile strengh [MPa] | 2.9 | 2.4 | 2.2 | 2.5 | 2.0 |
| Breaking extension [%] | 169 | 195 | 236 | 467 | 386 |
| Tear propagation resistance | 4.5 | 4.3 | 5.5 | 16.7 | 15.4 |
| [N/mm] | | | | | |
| Elasticity modulus 0-5% [MPa] | 4.8 | 3.8 | 2.0 | 2.0 | 2.0 |
| Elasticity modulus 0-25% | 3.5 | 3.0 | 1.7 | 1.4 | 1.2 |
| [MPa] | | | | | |
| Elasticity modulus 0-50% | 3.0 | 2.5 | 1.4 | 1.2 | 1.0 |
| [MPa] | | | | | |
| Elasticity modulus 0-100% | 2.3 | 2.0 | 1.3 | 1.0 | 0.8 |
| [MPa] | | | | | |
| Shore A | 60 | 55 | 46 | 20 | 37 |

Tables 6 to 9 show that even small amounts of the polymeric thixotropic agent B result in the compositions formulated therewith having flow resistance and being useful as adhesives. In particular it is apparent that the addition of the polymeric thixotropic agent B does not lead to any impairment, or any substantial impairment, in the mechanical properties.

### Suitability as Matting Agents

The gloss value was measured by means of light reflection on a layer 2 mm thick drawn down planarly onto a glass plate using a wood slot. After drying for 24 hours, a measurement was made of the gloss value as a triplicate determination using a gloss meter (Erichsen Pico Glossmaster 500—20°/60°) at a gloss angle of 60°.

TABLE 10
Compound B as a matting agent.

| Designation | KP-Ref. 1 | KP1 | KP2 | KP3 | KP4 | KP5 | KP6 |
|---|---|---|---|---|---|---|---|
| Amount of B | 0.00 | 1.75 | 2.25 | 3.00 | 3.50 | 4.00 | 5.25 |
| [% by weight] | | | | | | | |
| Gloss value (60°) | 73.9 | 58.9 | 45.4 | 16.2 | 9.6 | 6.8 | 3.2 |

It is evident from Table 10 that compound B acts as a matting agent. Even a small concentration of this substance results in a substantial loss of gloss by the composition.

What is claimed is:

1. A composition comprising:
at least one compound A having at least two reactive groups selected from the group comprising isocyanate, epoxide, alkoxysilane, and mixtures thereof, and
at least one polymeric thixotropic agent B prepared by:
homopolymerizing a (meth)acrylate B1, or
copolymerizing a (meth)acrylate B1 with at least one further (meth)acrylate, the (meth)acrylate mixture possessing an average (meth)acrylate functionality ƒ̅ of 2.5 to 4.5,
wherein the (meth)acrylate B1 having three or more (meth)acrylate groups.

2. The composition of claim 1, wherein the compound A is obtained by a reaction of a polyurethane prepolymer A3 containing at least two isocyanate groups with at least one compound AX which contains an NCO-reactive group, and also one or more epoxide or alkoxysilane groups.

3. The composition of claim 1, wherein the compound A is obtained by a reaction of a polymer A3-1 containing at least two isocyanate-reactive groups with at least one compound AY, the compound AY containing an NCO group and also one or more alkoxysilane groups.

4. The composition of claim 1, wherein the compound A is a compound A1, the compound A1 being selected from the group consisting of a diglycidyl ether of bisphenol A, bisphenol F, bisphenol A/F, and a mixture or an oligomer thereof.

5. The composition of claim 1, wherein the compound A is a compound A2-1, which is polyurethane prepolymer containing at least two alkoxysilane groups.

6. The composition of claim 1, wherein the compound A is a compound A2-2, which is polyether containing at least two alkoxysilane groups.

7. The composition of claim 6, wherein the compound A2-2 is obtained by a hydrosilylation reaction from polyether containing at least two C═C double bonds, and from a compound HSi(R¹)ₐ(OR²)₃₋ₐ, where R¹ and R² independently of one another represents a C₁-C₈-alkyl radical, and a represents the value 0 or 1.

8. The composition of claim 5, wherein the at least two alkoxysilane groups are trimethoxysilane or triethoxysilane groups.

9. The composition of claim 1, wherein the compound A is a compound A3, which is a polyurethane prepolymer containing at least two isocyanate groups.

10. The composition of claim 2, wherein the polyurethane prepolymer A3 containing at least two isocyanate groups is prepared from the reaction of at least one polyol with at least one polyisocyanate.

11. The composition of claim 10, wherein the at least one polyol is a polyoxyalkylene polyol.

12. The composition of claim 11, wherein the polyol is a polyoxyalkylene polyol having a degree of unsaturation <0.02 meq/g and a molecular weight Mₙ, of 1000 to 30,000 g/mol.

13. The composition of claim 1, wherein the (meth)acrylate B1 contains three, four or five (meth)acrylate groups and is selected from the group consisting of glycerol tri(meth)acrylate, tris(2-hydroxyethyl)isocyanurate tri(meth)acrylate, trimethylolpropane tri(meth)acrylate, ditrimethylolpropane tetra(meth)acrylate, pentaerythritol tetra(meth)acrylate, glucose penta(meth)acrylate, sorbitol hexa(meth)acrylate, dipentaerythritol hexa(meth)acrylate, and their ethoxylated or propoxylated analogs.

14. The composition of claim 1, wherein the polymeric thixotropic agent B is a copolymer, which is prepared from a (meth)acrylate mixture having an average (meth)acrylate functionality ƒ̅ of 2.5 to 3.5.

15. The composition of claim 1, wherein the composition comprises at least traces of the organic free-radical donor used for the free radical polymerization of the (meth)acrylates or derivative reaction products thereof.

16. The composition of claim 15, wherein the organic peroxide has a decomposition temperature T_{1/2} (1 h) of between 50° C. and 100° C.

17. The composition of claim 15, wherein the organic peroxide is a peroxide of a fatty acid.

18. The composition of claim 1, wherein the amount of polymeric thixotropic agent B is between 0.1% and 10% by weight based on the weight of the composition.

19. The composition of claim 1, wherein the composition further comprises at least one plasticizer.

20. The composition of claim 19, wherein the plasticizer is a phthalate or an adipate.

21. The composition of claim 1, wherein the composition further comprises at least one filler.

22. The composition of claim 21, wherein the amount of filler is between 25% and 50% by weight based on the weight of the composition.

23. A process for preparing a composition of claim 1, wherein the polymeric thixotropic agent B is added to the compound A.

24. A process for enchancing thixotropic properties of a composition, comprising providing the composition with a compound B prepared by:
homopolymerizing a (meth)acrylate B1, or
copolymerizing a (meth)acrylate B1 with at least one further (meth)acrylate,
the (meth)acrylate mixture having an average (meth)acrylate functionality ƒ̅ of 2.5 to 4.5,
the (meth)acrylate B1 having three or more (meth)acrylate groups.

25. The process of claim 24, wherein the (meth)acrylate B1 contains three, four or five (meth)acrylate groups and is selected from the group consisting of glycerol tri(meth)acrylate, tris(2-hydroxyethyl)isocyanurate tri(meth)acrylate, trimethylolpropane tri(meth)acrylate, ditrimethylolpropane tetra(meth)acrylate, pentaerythritol tetra(meth)acrylate, glucose penta(meth)acrylate, sorbitol hexa(meth)acrylate, dipentaerythritol hexa(meth)acrylate, and their ethoxylated or propoxylated analogs.

26. A process of adhering, sealing, coating or covering at least one object, comprising applying to said object a composition of claim 1 as an adhesive, sealant, coating or covering.

27. An article wherein the article is in contact with a composition of claim 1.

28. An article wherein the article is in frictional contact with a moisture-hardened composition of claim 1.
